(19) United States
(12) Patent Application Publication
(10) Pub. No.: US 2012/0089546 A1
(43) Pub. Date: Apr. 12, 2012

(54) METHODS AND SYSTEMS FOR AUTOMATED SURVEY SCRIPT AUTHORING AND PROGRAMMING

(75) Inventor: Akbar Saleem Ahmed, Concord, CA (US)

(73) Assignee: SYPENSIS, INC., Walnut Creek, CA (US)

(21) Appl. No.: 12/898,863

(22) Filed: Oct. 6, 2010

(51) Int. Cl. G06N 5/00

(52) U.S. Cl. 706/45

(57) ABSTRACT

A survey authoring and programming application parses and extracts information included in a questionnaire that consists of questions, answer options and instructions, and stores the information in a market research markup language (MRML) data model that abstracts the content, structure and instructions of the questionnaire. A logic engine then operates on the MRML representation of the questionnaire to produce one or more survey script outputs in any desired target survey programming language. The questionnaire may be written in a market research language (MRL).

### FIELD OF THE INVENTION

The present invention relates to methods and systems for automated survey script authoring and programming.

### BACKGROUND

Surveys are an essential tool for market research, political polls, and a number of other quantitative research applications. Today there exist a number of proprietary software platforms for developing and deploying surveys. Generally, these tools require survey developers to develop and code questions and related answer options, configure question properties, code instructions, and produce survey scripts that embody the questions, answers, properties, and instructions. The scripts are intended for deployment on computer-based platforms designed to run the individual scripts.

In order to reach as wide an audience as possible, survey developers often need to produce survey scripts for a number of different platforms. Often, this requires a highly skilled and experienced developer to separately code the survey for each such platform in a programming language that is unique to each platform. This is a labor intensive, time consuming, error prone and costly process.

### SUMMARY OF THE INVENTION

Research organizations have an immediate and pressing need to reduce labor dependence, expedite the survey generation process, reduce errors in that process, and lower their cost structures. The present invention satisfies these requirements.

A survey authoring and programming application configured in accordance with embodiments of the present invention may be instantiated as extensions to a word processing application, spreadsheet application, web service application or other host application, which serves as a user interface for a questionnaire author to create a market research or other survey. A questionnaire created in the host application may be parsed and information included in the questionnaire captured in a market research markup language (MRML) data model, which serves to abstract the content and structure of the questionnaire. A logic engine then operates on the MRML representation of the questionnaire to produce one or more survey script outputs. Those output scripts may be formatted for any desired target survey platform. In some instances, the questionnaire, as created in the host application, may contain questions and answer options and question properties and instructions written in market research language (MRL).

### BRIEF DESCRIPTION OF THE DRAWINGS

The present invention is illustrated by way of example, and not limitation, in the figures of the accompanying drawings in which:

FIG. 1 illustrates an example of a computer system on which instantiations of a survey authoring and programming application configured in accordance with the present invention may run;

FIG. 2 illustrates the architecture of a survey authoring and programming application configured in accordance with an embodiment of the present invention;

FIG. 3 illustrates an alternative view of the architecture of a survey authoring and programming application configured in accordance with embodiments of the present invention; and

FIG. 4 illustrates a survey authoring and programming application configured in accordance with an embodiment of the present invention.

### DETAILED DESCRIPTION

To address the need for survey developers to provide survey scripts suitable for execution on a number of different platforms, the present inventors have developed the present survey authoring and programming application. In one embodiment of the invention, a modified word processing application, spreadsheet application, web service application or other host application serves as a user interface for a questionnaire author to create a market research or other survey. For example, the modifications may come in the form of extensions to popular word processing applications, such as Microsoft Word™, but in other cases a custom word processing or other host application, such as Sipensys QNR Master™, may be used to create a questionnaire. Alternatively, an existing questionnaire created in a host application may be opened within a modified application configured in accordance with the present invention, and the content and structure of that questionnaire extracted in response to a menu or other command. Whether through authoring of the questionnaire or parsing of an existing questionnaire, information included in the questionnaire is captured in a market research markup language (MRML) data model, which serves to abstract the content and structure of the questionnaire. A logic engine then operates on the MRML representation of the questionnaire to produce one or more survey script outputs. Those output scripts may be formatted for any desired target survey platform.

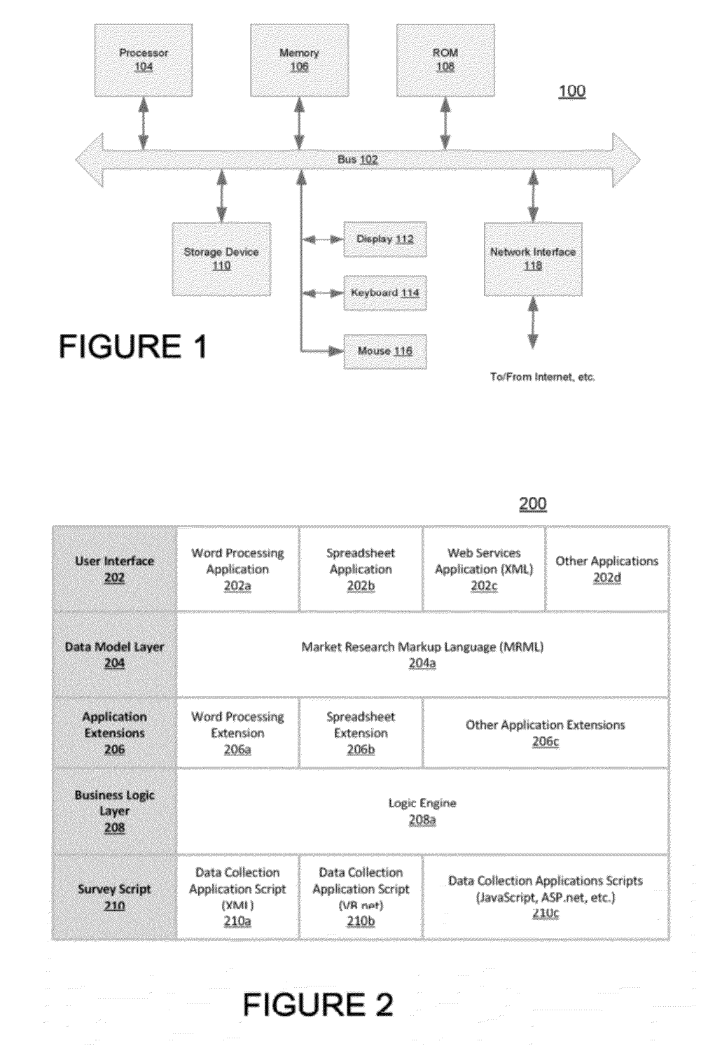

The present survey authoring and programming application may execute as an application on any computer system. As example of such a computer system 100 is illustrated in FIG. 1. Of course, this example is not intended to illustrate every possible computer system upon which embodiments of the invention may be implemented and is provided solely for purposes of illustrating a computer environment context for understanding operation of the survey authoring and programming application.

Computer system 100 includes a bus 102 or other communication mechanism for communicating information, and a processor 104 coupled with the bus 102 for processing information. Computer system 100 also includes a memory 106, such as a random access memory (RAM) or other dynamic storage device, coupled to the bus 102 for storing information and instructions to be executed by processor 104. Memory 106 also may be used for storing temporary variables or other intermediate information during execution of instructions to be executed by processor 104. Computer system 100 further includes a read only memory (ROM) 108 or other static storage device coupled to the bus 102 for storing static information and instructions for the processor 104. A storage device 110, such as a hard disk, is provided and coupled to the bus 102 for storing information and instructions.

Computer system 100 may also include a display 112, such as a flat panel display, for displaying information to a computer user. The display may be coupled to the processor 104 via bus 102. An input device, such as an alphanumeric keyboard 114, is also coupled to the bus 102 for communicating information and command selections to the processor 104. In addition, a cursor control device, such as a mouse 116, trackball, or cursor direction keys, are provided for communicating direction information and command selections to processor 104 and for controlling cursor movement on the display 112.

The survey authoring and programming application, including its user interface, data models and logic engines, may be instantiated as computer-executable instructions stored on a computer-readable storage medium, such as storage device 110. Such instructions may be read into memory 106 from storage device 110 for execution by processor 104. The computer-readable storage medium 110 is not limited to devices such as a hard drive and may include devices such as a floppy disk, a flexible disk, a storage medium, an optical storage medium, or memory such as RAM, programmable ROM (PROM), erasable PROM (EPROM), flash memory storage medium, any other memory or storage medium from which processor 104 can read instructions. Execution of the instructions contained in the memory 106 causes the processor 104 to perform the operations described below. In alternative embodiments, hard-wired circuitry may be used in place of or in combination with computer software instructions to implement instantiations of the invention.

Computer system 100 also includes a communication interface 118 coupled to the bus 102. Communication interface 118 provides a two-way data communication path between computer system 100 and remote computer systems, for example, via one or more computer networks such as the Internet. The data communication path provided via communication interface 118 may include wired and/or wireless communication links.

As indicated above, the survey authoring and programming application may be implemented as extensions to a conventional word processing or other application. This allows for parsing of a subject questionnaire created in the native language of the host application and transformation of its structure and content into an MRML data model which can be used to produce output survey scripts. The MRML data model is an extensible markup language (XML) schema that abstracts the subject questionnaire's structure and is implemented by embedding the XML into the word processing or other host application.

FIG. 2 illustrates the architecture of the survey authoring and programming application 200. A user interface layer 202 overlies a data model layer 204. The user interface layer may comprise a word processing application 202a, a spreadsheet application 202b, a web services application 202c, or another host application 202d, and, as mentioned, the data model layer is an MRML layer 204a. A preferred syntax (market research language or MRL) is used in the user interface to represent survey programming instructions. The MRML defines the manner in which the subject questionnaire, whatever its form, is parsed and the data extracted. It fully represents the questionnaire, and abstracts the questionnaire and programming instructions such that it can be used to provide a survey script in any desired format. As noted above, in some cases the application is instantiated as extensions 206 to existing word processing applications 206a, spreadsheet applications 206b or other applications 206c, but in other instances the application may be self contained.

A business logic layer 208, in the form of a logic engine 208a, operates on the extracted information represented in the MRML data model. This logic engine applies a complex series of decision making operations that replicate the decision making process of a human survey programmer and outputs a complete survey script 210. The survey script may be provided in any of a variety of programming languages that are used to write survey scripts, including XML files 210a, VB.NET files 210b, or JavaScript, ASP.NET, or other programming language files 210c used to program market research surveys.

FIG. 3 provides an alternative view of the architecture of a survey authoring and programming application 300 configured in accordance with embodiments of the present invention. Input questionnaires are provided via any of several input means, such as an authoring user interface 302a, a raw XML abstract 302b (e.g., as may be provided by a web services application), an existing document or spreadsheet 302c created using a host application, or other means. An adapter 304, which is the above-described MRML layer, parses the questionnaire, extracts the content and structure thereof, and stores this information as software objects in a data model and logic layer 310.

To create survey scripts, a second adapter 308 (e.g., the above-described logic engine) operates on the stored software objects that represent the original questionnaire. This results in one or more survey scripts 310a, 310b, 310.c being produced. The survey scripts may be provided in any desired survey platform programming language, including Confirmit™, IBM SPSS™ Data Collection™ and any other survey platform programming language.

Importantly, the present survey authoring and programming application does more than just translate an existing survey script from one syntax to another. The use of the MRML data model allows for a conceptual understanding of the original questionnaire. That is, the present application is able to fully abstract the content, structure and instructions of the questionnaire (effectively normalizing it) and represent it as a series of nodes, each with one or more associated finite state machines that represent the possible outcomes of the questions represented by the nodes. With such a data structure in place, the logic engine can construct survey programming scripts for any target platform. Stated differently, by producing an abstract model of the questionnaire, the present invention allows for that model to be instantiated in any desired programming language for a target survey platform.

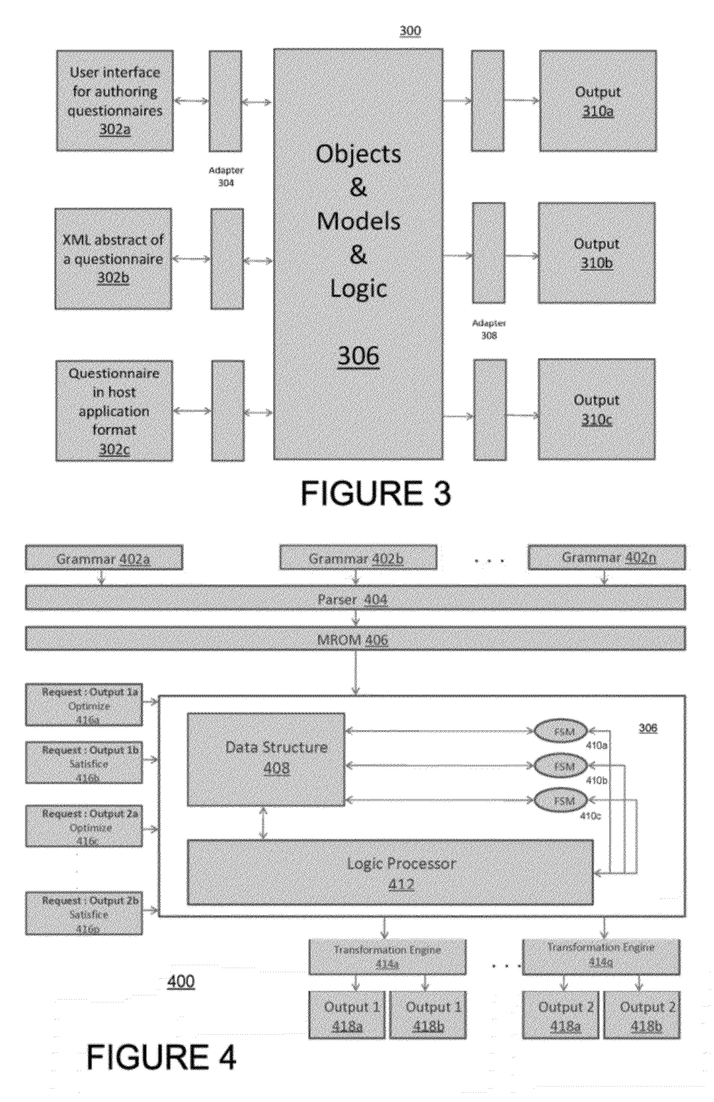

Referring now to FIG. 4, a survey authoring and programming application 400 configured in accordance with the present invention uses a number of different grammars 402a, 402b, . . . 402n, to parse documents, spreadsheets, or other instantiations of questionnaires created using different applications. The grammars are languages unique to the business domain for these host applications or other forms of input (e.g., if the questionnaire information is extracted from a database or is provided in an XML feeds, etc.

The input questionnaire information is provided to a parser 404. Parsers, such as parser 404, are well-known entities used to construct parsing tables in which various states are merged. The primary goal of any parser is to organize a sequence of tokens based on the rules of a formal language. Parser 404 operates on the input and produces a market research object model (MROM) 406. The object model represents the content of the subject questionnaire, and is stored in a graph-like data structure 408 made up of nodes and connecting links. Nodes may be questions, conditions, etc. The nodes are arranged in a tree-like structure via the links.

Each of the nodes is associated with a number of disconnected finite state machines 410a, 410b, . . . 410m. That is, each node is capable of being represented in a finite number of states, defined by the finite state machines associated with that node. For example, given a question, “What is your gender, male or female?”, the question may be represented by a finite state machine having four possible outcomes, male, female, male and female, neither male nor female. Of course, the latter two states are nonsensical (at least in the context of the present survey question), and so are eliminated. The two remaining options, male (i.e., male true, female false) and female (male false, female true) are represented in the finite state machine associated with the survey question node in the data structure.

The finite states are determined as a result of the parsing process, but they generally do not link together well. The logic processor 412 acts as business logic to read through the data structure and, according to a set of rules link the finite state, machines together to represent the structure of the original questionnaire. This will be an abstracted representation of the instructions defined by the questionnaire, e.g., the various outcomes, dependencies and/or exclusivities defined by the questions and answer possibilities of the original questionnaire. The linking operations are defined by the outcomes permitted by the finite state machines and the rules executed by the logic processor.

Once the abstracted questionnaire has been produced and stored, it can be used to produce the various output scripts. Transformation engines 414a-414q, etc. are provided for the various target scripting languages. Each transformation engine has associated programming rules for its target programming langue so that by reading the data structure and associated, linked finite state machines that represent the questionnaire, the transformation engines are able to create the survey script in the desired target language.

As shown, various options 416a-416p, such as optimization or satisficing, may be provided to allow an operator to select how the survey script should be programmed. Satisficing is a decision making strategy that attempts to meet criteria for adequacy, rather than to identify an optimal solution (which is the goal of an optimization strategy). Each transformation engine 414 may thus produce an optimized output survey script 418a or a satisficed output survey script 418b, or any other desired form of survey script.

Thus, methods and systems for automated survey script authoring and programming have been described. The foregoing discussion of examples of a survey script authoring and programming application is not intended to be limiting in nature and he present invention should be measured only in terms of the claims, which follow.

What is claimed is:

1. A computer-implemented process, comprising extracting information from a questionnaire authored in a host domain language; storing the information as objects in a market research markup language (MRML) representation of the questionnaire, which abstracts content and structure of the questionnaire; and operating a logic engine on the MRML representation of the questionnaire to produce one or more survey script outputs formatted for a target survey programming language.

2. The computer-implemented process of claim 1, wherein the MRML representation of the questionnaire comprises a graph-like structure of nodes, each with one or more associated finite state machines representing permitted outcomes of questions of the questionnaire.

3. The computer-implemented process of claim 2, wherein operating the logic engine comprises linking various ones of the finite state machines to replicate the structure of the questionnaire.

4. The computer-implemented process of claim 1, wherein the host domain language is market research language (MRL).

5. A computer system, comprising, a processor and a computer-readable storage medium coupled to the processor, the computer-readable storage medium storing computer-executable instructions which, when executed by the processor, cause the processor to extract information from a questionnaire authored in a host domain language, store the information as objects in a market research markup language (MRML) representation of the questionnaire, which abstracts content, structure and instructions of the questionnaire, and operate a logic engine on the MRML representation of the questionnaire to produce one or more survey script outputs formatted for a target survey programming language.

6. The computer system of claim 5, wherein the MRML representation of the questionnaire comprises a graph-like structure of nodes, each with one or more associated finite state machines representing permitted outcomes of questions of the questionnaire.

7. The computer system of claim 6, wherein operating the logic engine comprises linking various ones of the finite state machines to replicate the structure of the questionnaire.
